(19) United States
(12) Patent Application Publication
(10) Pub. No.: US 2010/0207959 A1
(43) Pub. Date: Aug. 19, 2010

(54) LCD TEMPORAL AND SPATIAL DITHERING

(75) Inventors: Jun Qi, Cupertino, CA (US); Wei Chen, Palo Alto, CA (US); Moo Kyung Son, Sunnyvale, CA (US); Victor H. Yin, Cupertino, CA (US); John Z. Zhong, Cupertino, CA (US)

Correspondence Address: APPLE INC.;c/o Fletcher Yoder, PC, P.O. Box 692289, Houston, TX, 77269-2289, US

(73) Assignee: Apple Inc., Cupertino, CA (US)

(21) Appl. No.: 12/371,480

(22) Filed: Feb. 13, 2009

(51) Int. Cl. G09G 5/02; G06T 1/00

(52) U.S. Cl. 345/597; 345/522

(57) ABSTRACT

A method and system for temporal dithering of pixels in a display. The dithering of the pixels may allow for simulation of 8-bit color from a 6-bit display. Moreover, the dithering of the pixels may be selected to follow a specific pattern to minimize display artifacts, which might otherwise result from interference generated by pixel inversion techniques performed during the pixel dithering. Through application of selective dithering techniques, including utilization of specific dithering patterns, the generation of display artifacts via interference from pixel inversion techniques during the display of an image may be minimized.

### BACKGROUND

This relates generally to minimizing artifacts generated through dithering of pixels in a display when applied to a display that utilizes pixel inversion techniques.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Liquid crystal displays (LCDs) are commonly used as screens or displays for a wide variety of electronic devices, including such consumer electronics as televisions, computers, and handheld devices (e.g., cellular telephones, audio and video players, gaming systems, and so forth). Such LCD devices typically provide a flat display in a relatively thin and low weight package that is suitable for use in a variety of electronic goods. In addition, such LCD devices typically use less power than comparable display technologies, making them suitable for use in battery powered devices or in other contexts where it is desirable to minimize power usage.

LCD devices typically include thousands (or millions) of picture elements, i.e., pixels, arranged in rows and columns. For any given pixel of an LCD device, the amount of light that viewable on the LCD depends on the voltage applied to the pixel. However, applying a single direct current (DC) voltage could eventually damage the pixels of the display. Thus, to prevent such possible damage, LCD's typically alternate, or invert, the voltage applied to the pixels between positive and negative DC values for each pixel.

To display a given color at a given pixel, the LCD device may receive 24-bits of image data, whereby 8-bits of data correspond to each of the primary colors of red, green, and blue. However, as the transition time for these displays have increased, pixels receiving 24-bits of data may not transition to a new color rapidly enough, which may lead to an undesired effect on the image termed “motion blurring.” To minimize this motion blurring, response times of the LCD's may be increased. One manner in which to improve response times of the LCD's may include receiving 6-bits of data corresponding to each of the primary colors instead of 8-bits.

The reduction of data bits corresponding to colors may allow the pixels of the LCD to transition from one level to another more rapidly, however, it may also reduce the number of levels (i.e., colors) that each pixel may be able to render. To overcome this reduction in levels, dithering of the pixels may be performed. Dithering of the pixels may include applying slightly varying shades of color in a group of adjacent pixels to “trick” the human eye into perceiving the desired color, despite the fact that none of the pixels may be actually displaying the desired color.

The use of dithering may allow LCD's that receive 6-bit color data to simulate colors achievable by 8-bit color data LCD's. However, use of dithering may, in combination with the LCD inversion techniques discussed above, lead to generation of visible artifacts on the LCD. Accordingly, there is a need for dithering techniques that do not interfere with the inversion techniques of the LCD.

### SUMMARY

Certain aspects commensurate with certain disclosed embodiments are set forth below. It should be understood that these aspects are presented merely to provide the reader with a brief summary of the disclosure and that these aspects are not intended to limit the scope of the disclosure or the claims. Indeed, the disclosure and claims may encompass a variety of aspects that may not be set forth below.

The present disclosure relates to incorporation of dithering techniques into an LCD. The dithering techniques may operate to reduce interference with inversion techniques for an LCD, leading to a reduction in visible artifacts displayed on the LCD. The dithering techniques may include rotation of a single pixel intensity level across a two-dimensional grid of pixels such that the single pixel intensity level is consistently being driven with the same voltage, i.e., always a positive or always a negative voltage. The dithering techniques may also include utilization of a four frame rotational scheme for situations in which dual pixel intensity levels are utilized in a two-dimensional grid of pixels. The dithering techniques may be utilized in conjunction with a two-dot inversion method of the LCD.

### BRIEF DESCRIPTION OF THE DRAWINGS

Advantages of the disclosure may become apparent upon reading the following detailed description and upon reference to the drawings in which:

FIG. 1 is a perspective view illustrating an electronic device in accordance with one embodiment;

FIG. 2 is a simplified block diagram illustrating components of an electronic device in accordance with one embodiment;

FIG. 3 is a simplified block diagram illustrating components of the display control logic of FIG. 2 in accordance with one embodiment;

FIG. 4 is a simplified diagram of a two dimensional grid of pixels utilizing spatial dithering in accordance with one embodiment;

FIG. 5 is a simplified diagram of a two dimensional grid of pixels utilizing spatial dithering in accordance with one embodiment;

FIG. 6 is a simplified diagram of a two dimensional grid of pixels utilizing spatial dithering in accordance with one embodiment;

FIG. 7 is a simplified diagram of a two dimensional grid of pixels utilizing temporal dithering over four frames in accordance with one embodiment;

FIG. 8 is a simplified diagram of a two dimensional grid of pixels utilizing temporal dithering over two frames in accordance with one embodiment;

FIG. 9 is a simplified diagram of a two dimensional grid of pixels utilizing dot inversion over two frames in accordance with one embodiment;

FIG. 10 is a simplified diagram of a two dimensional grid of pixels utilizing two-dot inversion over two frames in accordance with one embodiment;

FIG. 11 is a simplified diagram of a two dimensional grid of pixels utilizing two-dot inversion in conjunction with temporal dithering;

FIG. 12 is a simplified diagram of a two dimensional grid of pixels utilizing two-dot inversion in conjunction with temporal dithering in accordance with one embodiment;

FIG. 13 is a simplified diagram of a two dimensional grid of pixels utilizing two-dot inversion in conjunction with temporal dithering;

FIG. 14 is a simplified diagram of a two dimensional grid of pixels utilizing two-dot inversion in conjunction with temporal dithering in accordance with another embodiment;

FIG. 15 is a simplified diagram of a two dimensional grid of pixels utilizing two-dot inversion in conjunction with temporal dithering;

FIG. 16 is a simplified diagram of a two dimensional grid of pixels utilizing two-dot inversion in conjunction with temporal dithering in accordance with another embodiment.

### DETAILED DESCRIPTION OF SPECIFIC EMBODIMENTS

This disclosure is generally directed to dithering techniques utilized in conjunction with a two-dot inversion method for an LCD. The dithering techniques may include a combination of spatial dithering, whereby a small group of pixels or sub-pixels (such as a 2×2 frame) may be driven to varying shades of color to simulate an overall desired color, despite the fact that none of the pixels or sub-pixels may be actually displaying the desired color, and temporal dithering, whereby the intensities of a small group of pixels or sub-pixels (such as a 2×2 frame) may be rearranged within the small group of pixels or sub-pixels on a frame by frame basis. This combination of spatial and temporal dithering may include rotation of a selected intensity across the small group of pixels or sub-pixels such that the selected intensity level is consistently being driven with the same voltage, e.g., always a positive or always a negative voltage, to coincide with various inversion techniques being applied to the pixels or sub-pixels and may approximate an overall intensity value across multiple frames. The dithering techniques may also include rotation of dual intensity levels across both positive and negative voltage values to reduce horizontal line artifacts related to interference with various inversion techniques, such as two-dot inversion.

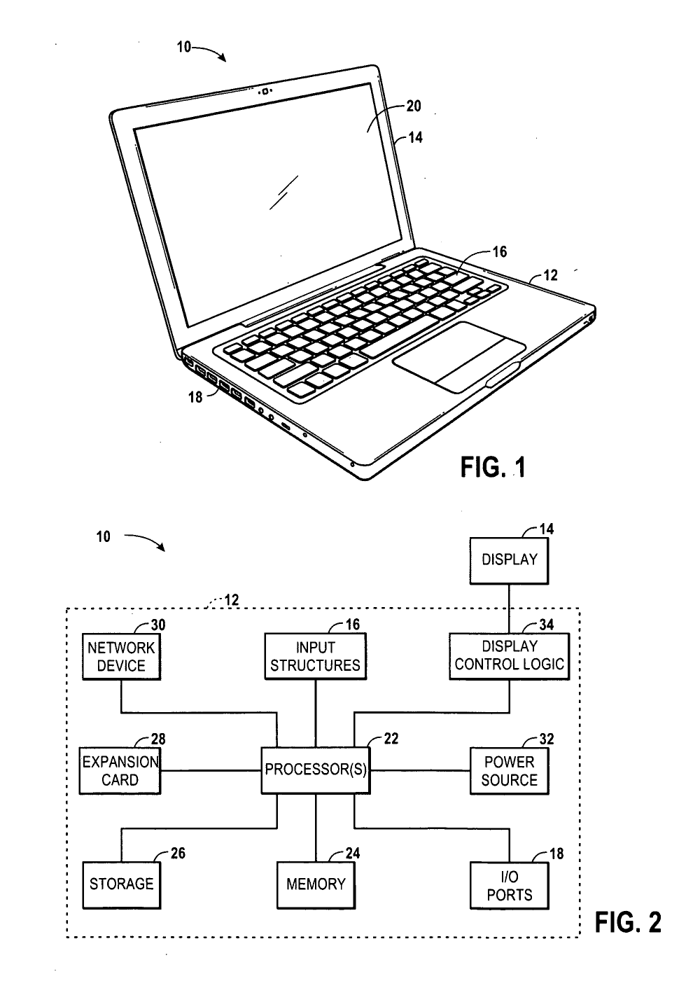

With these features in mind, a general description of suitable electronic devices using LCD displays utilizing dithering of pixels that reduce interference with two-dot inversion of the LCD is provided below. An example of electronic device 10 is illustrated in FIG. 1 in accordance with one embodiment. In some embodiments, including the one shown in FIG. 1, device 10 may be a portable electronic device, such as a portable computer (such as a laptop, notebook, or tablet computer). Other electronic devices may also include a viewable media player, a cellular phone, a personal data organizer, or the like. Moreover, while certain embodiments are described with respect to a portable electronic device, it should be noted that the presently disclosed techniques may be applicable to a wide array of other electronic devices and systems that may render graphical data, such as a desktop computer.

In certain embodiments, electronic device 10 in the form of a computer may be a model of a MacBook®, MacBook® Pro, MacBook Air®, iMac®, Mac® mini, or Mac Pro® available from Apple Inc., of Cupertino, Calif. By way of example, electronic device 10, in the form of a laptop computer illustrated in FIG. 1, can include housing 12, display 14, input structures 16, and input/output ports 18.

Housing 12 may be formed from plastic, metal, composite materials, or other suitable materials, or any combination thereof. Housing 12 may protect the interior components of electronic device 10 from physical damage, and may also shield the interior components from electromagnetic interference (EMI). Display 14 may be operably connected to enclosure 12.

Display 14 may include liquid crystal display (LCD) 20. Display 14 may be utilized to display the respective operating system and application interfaces running on electronic device 10 and/or to display data, images, or other visual outputs associated with an operation of electronic device 10.

Input structures 16 of electronic device 10 may control device 1 0, such as by controlling a mode of operation, an output level, an output type, etc. of the device. Embodiments of electronic device 10 may include any number of input structures 16, including buttons, switches, a control pad, a keyboard, or any other suitable input structures. Input structures 16 may operate to control functions of electronic device 10 and/or any interfaces or devices connected to or used by electronic device 10. In one embodiment, one or more of the input structures 16 may allow a user increase or decrease the brightness of display 14.

As shown, device 10 may also include various input and output ports 18 to allow connection of additional devices. For example, device 10 may include headphone and headset jacks, universal serial bus (USB) ports, IEEE-1394 ports, Ethernet and modem ports, AC and/or DC power connectors, and so forth. Further, electronic device 10 may use the input and output ports 18 to connect to and send or receive data with any other device, such as a modem, networked computers, printers, external storage devices, or the like. For example, in one embodiment, electronic device 10 may connect to an ipod® via a USB connection to send and receive data files, such as media files.

In embodiments in which electronic device 10 includes LCD 20, LCD 20 may typically include an array or matrix of picture elements (i.e., pixels). In operation, the LCD 20 generally operates to modulate the transmittance of light through each pixel by controlling the orientation of liquid crystal disposed at each pixel such that the amount of light emitted by each pixel is controlled. In embodiments where LCD 20 is a color display, each pixel may include a group of sub-pixels, such as a red sub-pixel, a green sub-pixel, and a blue sub-pixel. The intensity of light allowed to pass through each sub-pixel (by modulation of the corresponding liquid crystals), and its combination with the light emitted from other adjacent sub-pixels, determines what color(s) are perceived by a user viewing the display.

An example of the internal components suitable for operation of electronic device 10 are illustrated in FIG. 2. FIG. 2 is a block diagram illustrating the components that may be present in electronic device 10 and which may allow device 10 to function in accordance with the techniques discussed herein. Those of ordinary skill in the art will appreciate that the various functional blocks shown in FIG. 2 may comprise hardware elements (including circuitry), software elements (including computer code stored on a computer-readable medium) or a combination of both hardware and software elements. It should further be noted that FIG. 2 is merely one example of a particular implementation and is merely intended to illustrate the types of components that may be present in device 10. For example, in the presently illustrated embodiment, these components may include display 14, input structures 16, and I/O ports 18 as discussed above. Further, the components may include one or more processors 22, memory device 24, non-volatile storage 26, expansion card(s) 28, networking device 30, power source 32, and display control logic 34. Elements 16,18, and 22-34 may be disposed inside of enclosure 12, which may be coupled to display 14.

Processor(s) 22 may provide the processing capability to execute the operating system, programs, user and application interfaces, and any other functions of electronic device 10. Processor(s) 22 may include one or more microprocessors, such as one or more “general-purpose” microprocessors, one or more special-purpose microprocessors and/or ASICS, or some combination of such processing components. For example, processor 22 may include one or more reduced instruction set (RISC) processors, as well as graphics processors, video processors, audio processors and/or related chip sets.

The instructions or data to be processed by processor(s) 22 may be stored in a computer-readable medium, such as memory 24. Memory 24 may be provided as a volatile memory, such as random access memory (RAM), and/or as a non-volatile memory, such as read-only memory (ROM). Memory 24 may store a variety of information and may be used for various purposes. For example, memory 24 may store firmware for electronic device 10 (such as a basic input/output instruction or operating system instructions), various programs, applications, or routines executed on electronic device 10, user interface functions, processor functions, and so forth.

The components may further include other forms of computer-readable media, such as non-volatile storage 26, for persistent storage of data and/or instructions. Non-volatile storage 26 may include flash memory, a hard drive, or any other optical, magnetic, and/or solid-state storage media. Non-volatile storage 26 may be used to store firmware, data files, software, wireless connection information, and any other suitable data.

The embodiment illustrated in FIG. 2 may also include one or more card or expansion slots. The card slots may receive expansion card 28 that may be used to add functionality, such as additional memory, I/O functionality, or networking capability, to electronic device 10. Expansion card 28 may connect to the device through any type of suitable connector, and may be accessed internally or external to the housing of electronic device 10. For example, in one embodiment, expansion card 28 may be flash memory card, such as a SecureDigital (SD) card, mini- or microSD, CompactFlash card, Multimedia card (MMC), or the like.

The components depicted in FIG. 2 also include network device 30, such as a network controller or a network interface card (NIC). In one embodiment, network device 30 may be a wireless NIC providing wireless connectivity over any 802.11 standard or any other suitable wireless networking standard. Network device 30 may allow electronic device 10 to communicate over a network, such as a Local Area Network (LAN), Wide Area Network (WAN), or the Internet.

Further, the components may also include power source 32. In one embodiment, power source 32 may be one or more batteries, such as a lithium-ion polymer battery or other type of suitable battery. The battery may be user-removable or may be secured within the housing of electronic device 10, and may be rechargeable. Additionally, power source 32 may include AC power, such as provided by an electrical outlet, and electronic device 10 may be connected to power source 32 via a power adapter. This power adapter may also be used to recharge one or more batteries if present.

The internal components may further include display control logic 34. Display control logic 34 may be coupled to display 14 and to processor(s) 22. Display control logic 34 may be used to receive a data stream, for example, from processor(s) 22, indicative of an image to be represented on display 14. Display control logic 34 may be an application specific integrated circuit (ASIC), or any other circuitry for adjusting image data and/or generate images on display 14.

In one embodiment, display control logic 34 may receive a data stream equivalent to 24 bits of data for each pixel of display 14, with 8-bits of the data stream corresponding to a level for each of the primary colors of red, blue, and green for each sub-pixel. Display control logic 14 may operate to convert these 24 bits of data for each pixel of display 14 to 18-bits of data for each pixel of display 14, that is, 6-bits of the data stream corresponding to a level for each of the primary colors of red, blue, and green for each sub-pixel. This conversion may, for example, include removal of the two least significant bits of each of the 8-bits of the data stream corresponding to a level for each of the primary colors of red, blue, and green. Alternatively, the conversion may, for example, include a look-up table or other means for determining which 6-bit data value should correspond to each 8-bit data input. I

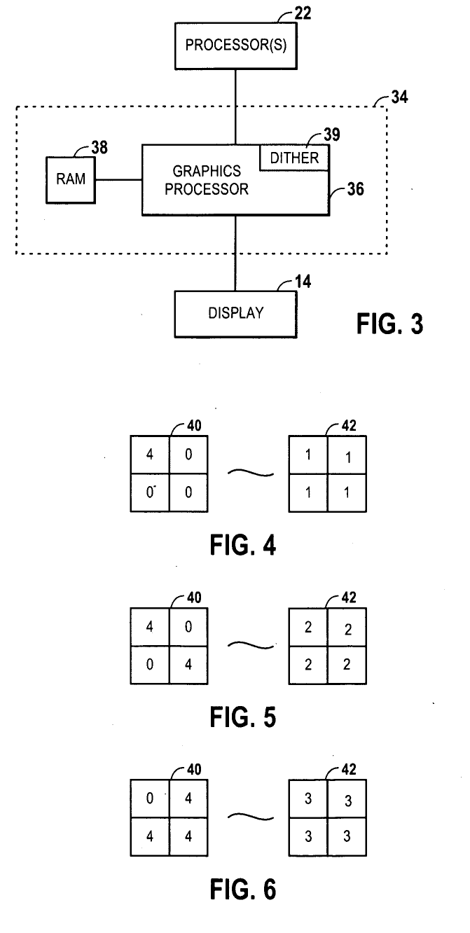

FIG. 3 illustrates components of display control logic 34 of FIG. 2 in accordance with one embodiment. As illustrated, display control logic 34 may be positioned between processor(s) 22 and display 14. Display control logic 34 may include graphics processor 36 that may operate to generate images on display 14 of electronic device 10. Graphics processor 36 may be a device that receives pixel intensity levels from processor(s) 22 and may transmit signals corresponding to those pixel intensity levels to display 14. As set forth above, the received pixel intensity levels, i.e. an image code from processor(s) 22, may be a 24-bit data stream and the transmitted voltage levels, i.e., an image code for display on display 14, may correspond to an 18-bit data stream (when, for example, LCD 20 is a 6-bit display). The pixel intensity levels transmitted to display 14 may be, for example, numerical levels that correspond to respective pixel intensities to be shown on display 14. Display 14 may thus receive the voltage signals from graphics processor 36 as input signals, and may produce an image corresponding to the received voltage signals. The manner in which an image is produced as described below.

Graphics processor 36 may, for example, utilize RAM 38 in performing the functions required by display control logic 34. One of the functions of RAM 38 may be the storage of a look-up table utilized by graphics processor 36 to convert the received 24-bit data stream into an 18-bit data stream for display on the 6-bit display 14. Another function of RAM 38 may be to store an algorithm corresponding to a dithering technique to be performed by graphics processor 36. This algorithm may allow for the dithering of the pixels of display 14. That is, the dithering algorithm may be computer code adapted to be stored in RAM 38 and to be operated on by graphics processor 36 to illuminate a small grouping of pixels, such as four pixels, with slightly varying shades of color that “trick” the human eye into perceiving the desired color, despite the fact that the small group of pixels may not be actually displaying the desired color.

Alternatively, graphics processor 36 may include dithering circuitry 39, or dithering circuitry 39 may be located external to graphics processor 36 either in or outside of display control circuit 34. Regardless of the location of dithering circuitry 39, dithering circuitry 39 may be adapted to perform dithering of the pixels in display 14 in a manner substantially similar to that described above. Furthermore, graphics processor 36 may also perform inversion techniques in the pixels of display 14. For example, the inversion techniques may be stored as computer readable code adapted to be stored in RAM 38 and to be operated on by graphics processor 36 to perform inversion of pixels in display 14. Regardless of whether dithering circuitry 39 or graphics processor 36 in conjunction with RAM 38 performs the dithering, an example of a result of dithering, i.e., spatial dithering, is shown with respect to FIGS. 4 through 6.

FIG. 4 illustrates four-pixel grid 40 for use with 6-bit LCD display 14. Four pixel grid 40 may be utilized to simulate an 8-bit LCD color display via dithering. The simulated, i.e., resultant, colors for an 8-bit LCD display are illustrated by four-pixel grid 42. It should be noted that while only four pixels are illustrated in FIG. 4, this pattern of pixel arrangement may be reproduced for the entire display 14, for example, in groups of four pixels arranged into 2-dimensional grids.

In FIG. 4, four-pixel grid 40 shows an intensity level of “4” in the upper left quadrant of a two-by-two pixel grid. The remaining quadrants of four-pixel grid 40 may be illustrated with intensity levels of “0”. The grid levels may, for example, correspond to intensity levels of LCD display 14. For example, an intensity level of “0” might correspond to the darkest possible color, i.e., black, while “63” may correspond to the brightest color available, i.e., white, for a 6-bit display 14. The remaining levels between “0” and “63” may correspond to the available grey levels and/or colors that may be displayed at any given pixel location. Conversely, in an 8-bit LCD display, “0” may correspond to black while “255” may correspond to white, with the remaining levels between “0” and “255” corresponding to the available grey levels and/or colors that may be displayed at any given pixel location. That is, in a 6-bit display, 26 colors, or levels, may be available for display while in the 8-bit display, 28 colors may be available for display.

To help approximate the extra colors available for display in the 8-bit display, spatial dithering of four bit pixel grid 40 in the 6-bit display 14 may be performed. That is, to approximate four pixels having intensity levels of “1”, as illustrated in four pixel grid 42, four pixel grid 40 may include an intensity level of “4” in the upper left quadrant, as well as three intensity levels of “0” in the remaining quadrants. The combined intensity level of these quadrants is “4”. Similarly, the combined intensity level of an 8-bit display displaying intensity levels of “1” at each of the pixels would also be “4”. Therefore, when viewed at a distance, a user may see the overall value of four pixel grid 40 of the 6-bit display 14 as approximating an 8-bit display displaying pixel intensities of “1”, as illustrates in four pixel grid 42.

FIG. 5 shows a second example of spatial dithering. FIG. 5 includes intensity levels of “4” in the upper leftmost quadrant and the lower rightmost quadrant of four pixel grid 40, for a total intensity value of “8”. Similarly, the combined intensity level of an 8-bit display displaying intensity levels of “2” at each of the pixels would also be “8”. FIG. 5 also illustrates the approximate grid generated by four pixel grid 40 of the 6-bit display 14, as shown in four pixel grid array 42 approximately displaying pixel intensity values of “2” at each pixel. Accordingly, four pixel grid 40 of FIG. 5 may approximate to a user as a distance an average intensity level of “2” for the four pixels of four pixel grid 40, thus simulating a four pixel grid for an 8-bit LCD display displaying an intensity of “2” at each pixel.

FIG. 6 shows another example of dithering for use with 6-bit LCD display 14. Four pixel grid 40 illustrated in FIG. 6 includes an intensity level of “0” in the upper leftmost quadrant along with intensity levels of “4” in all remaining quadrants. This leads to a total pixel intensity of “12”, which, in a similar manner to that described above, which may be approximated as four pixel grid 42 displaying pixels each at an intensity of “3” in each quadrant. Thus, to a user located at a distance, four pixel grid 40 of FIG. 6 may approximate the intensity of an 8-bit display displaying intensity values of “3” in each pixel.

In this manner, FIGS. 4-6 illustrate the ability to show pixel intensities equivalent to either “1”, “2”, or “3”, utilizing only pixel levels of “0” and “4”. Moreover, these specific examples may be applied to all of the pixel intensities from “0” to “255” of an 8-bit display. However, while utilization of spacial dithering may adequately represent the various pixel intensity levels of an 8-bit display on 6-bit display 14, spatial dithering may also cause artifacts to be perceived by the user on display 14.

For example, in FIG. 4, the upper left most quadrant of four pixel grid 40 has an intensity level of “4”. Accordingly, as described above, a user may see an overall value of approximately “1” across the four pixels in four pixel grid 40. However, the upper leftmost portion of four pixel grid 40 may appear to be brighter than the remaining three pixels (since it has an intensity of “4” while the neighboring pixels all have an intensity of “0”). Similarly, in FIG. 5 the upper leftmost and lower rightmost quadrants may have a brighter intensity than the remaining pixels of four pixel grid 40. Finally, in FIG. 6, there may be a lesser intensity visible in the upper leftmost quadrant four pixel grid 40 versus the remaining three quadrants. Accordingly, temporal dithering may be applied to help limit these visual artifacts.

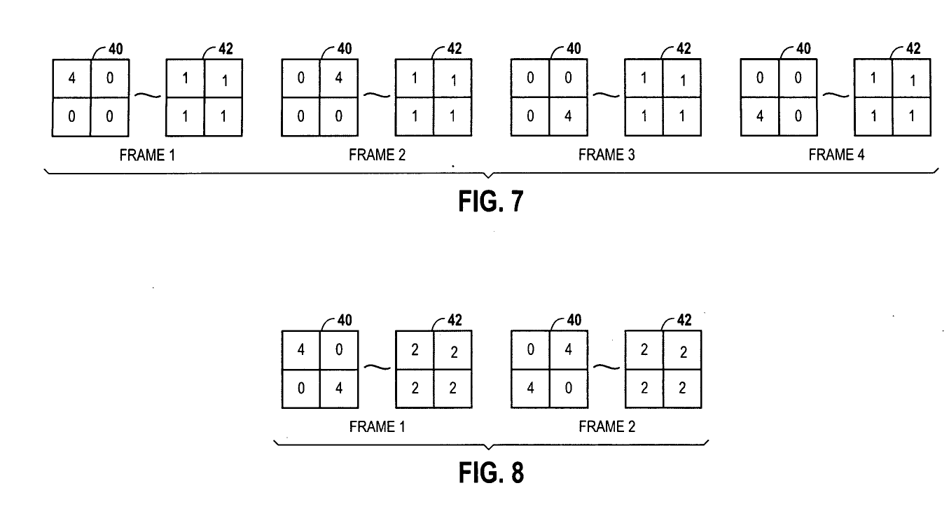

FIG. 7 illustrates an example of temporal dithering. The temporal dithering may include, for example, spatial dithering intensities illustrated in four pixel grid 40 of FIG. 4. However, any of the spatial dithering processes discussed above with respect to FIGS. 4-6 may be utilized in conjunction with the temporal dithering illustrated in FIG. 7. FIG. 7 illustrates four pixel grid 40 of 6-bit display 14 that is utilized to approximate an intensity level of “1” for each pixel, as shown in four pixel grid 42, by incorporating an intensity level of “4” along with three intensity levels of “0”.

In Frame 1, the intensity level of “4” in four pixel grid 40 is in the upper leftmost quadrant. As discussed above, if the intensity level of “4” is maintained in this position in four pixel grid 40, a user may be able to view the difference in brightness in the upper left hand corner of four pixel grid 40 as an artifact. Accordingly, in Frame 2, utilization of temporal dithering may allow for the “rotation” of the intensity level of “4” to the upper rightmost quadrant of four pixel grid 40. This “rotation” may include changing the voltage supplied to the pixel in the upper leftmost quadrant to generate a “0” level, while changing the voltage supplied to the pixel in the upper rightmost quadrant to generate an intensity level of “4”. In Frame 3, temporal dithering may be utilized to rotate the pixel intensity of “4” to the bottom right hand quadrant of four pixel grid 40. Finally, in Frame 4, the temporal dithering may cause the pixel intensity level of “4” to rotate to the bottom left hand quadrant of four pixel grid 40.

Thus, as can be seen in FIG. 7, in each of Frame 1, Frame 2, Frame 3, and Frame 4, the total intensity value of four pixel grid 40 is approximately equivalent to intensity levels of “1” in each of the quadrants of four pixel grid 42. However, because the intensity level of “4” is rotated amongst the quadrants of four pixel grid 40, any brightness due to the intensity of a single quadrant being higher than the remaining quadrants is balanced across the four quadrants of four pixel grid 40 over four frames. This rotation of the higher intensity level may operate to blend the overall intensity of four pixel grid 40. Furthermore, when this method is applied to a plurality of four pixel grids 40 in display 14, a more uniform image may be displayed to the user.

FIG. 8 illustrates another example of the temporal dithering discussed above with respect to FIG. 7, with two pixels being driven with a first intensity and two pixels being driven with a second intensity. Four pixel grid 40 of FIG. 8 may be analogous to four pixel grid 40 illustrated with respect to FIG. 5. That is, four pixel grid 40 of FIG. 8 may be used to approximate intensity levels of “2” for each pixel, as shown in four pixel grid 42. As such, in Frame 1 of FIG. 8, intensity levels of “4” may be displayed in the upper leftmost and lower rightmost quadrants of four pixel grid 40. Subsequently, in Frame 2, the intensity levels of “4” may be rotated to the upper rightmost and lower leftmost quadrants of four pixel grid 40. Thus, in both Frame 1 and Frame 2, four pixel grid 40 may have an overall pixel intensity value of “8” which, to a user, may approximate four pixels having intensity levels of “2”, as illustrated in four pixel grid 42. Moreover, by rotating the intensities across the quadrants of four pixel grid 40, any brightness due to the intensity of a two quadrants having higher intensities than the remaining quadrants is balanced across the four quadrants of four pixel grid 40 over two frames. It should be noted that the rotation illustrated in Frame 1 may be repeated for Frame 3 and any subsequent odd frames, while the rotation illustrated in Frame 2 may be repeated for Frame 4 and any subsequent even frames.

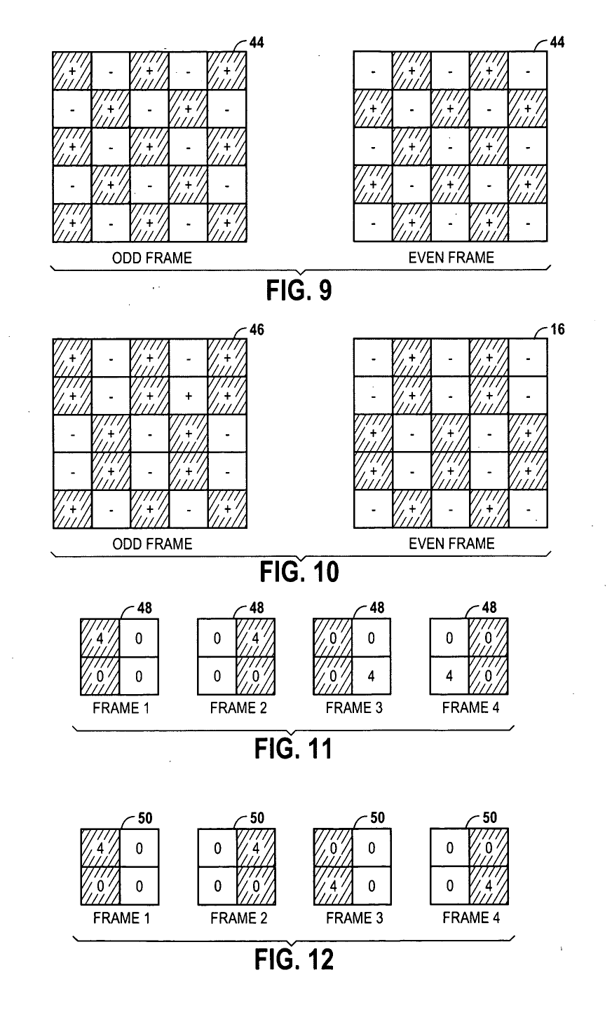

Thus, as can be seen in both FIGS. 7 and 8, temporal dithering may reduce any artifacts due to isolated brightness of pixels in a four pixel grid 40. However, as described above, dithering in display 14 is not utilized alone, but rather, in conjunction with an inversion of pixels in display 14. FIG. 9 illustrates a first inversion method that may be used in display 14. For example, twenty-five (5×5) pixel grid 44 may be a portion of display 14 and that utilizes a one dot inversion method. In an odd frame, twenty-five pixel grid 44 may include twenty-five pixels, each with a corresponding voltage applied to the pixel locations. The applied voltage to the pixels may alternate between a positive and a negative voltage on a pixel by pixel basis. That is, the top most row, the third row, and the fifth rows, i.e., rows 1, 3, and 5 of twenty-five pixel grid 44, may include five pixels that receive a positive voltage (in columns one, three, and five) and a negative voltage (in columns two and four). Conversely, the second and fourth rows, i.e., rows 2 and 4 of twenty-five pixel grid 44, may include five pixels that receive a positive voltage (in columns two and four) and a negative voltage (in columns one, three and five).

During an even frame, rows 1, 3, and 5 of twenty-five pixel grid 44, may include five pixels that receive a positive voltage (in columns two and four) and a negative voltage (in columns one, three and five). Conversely, the second and fourth rows, i.e., rows 2 and 4 of twenty-five pixel grid 44, may include five pixels that receive a positive voltage (in columns one, three and five) and a negative voltage (in columns two and four) during an even frame. Thus, during the even frame, the pixels previously driven with positive voltage in the odd frame are now driven with negative voltage and vice versa.

Regardless of an odd or an even frame, pixels in the same row alternate between receiving a positive and a negative voltage. In effect, this driving of the pixels with positive and negative voltages may generate a checkerboard pattern on twenty-five pixel grid 44, and the same is done for the remainder of display 14. While this inversion technique may operate to extend the life of display 14, as discussed previously, it may utilize more power than other inversion techniques. Additionally, this inversion technique may result in an increased flicker level in display 14 relative to other inversion techniques. For example, a two dot inversion method, which may consumes less power than the one dot inversion method with a reduced flicker level, is illustrated in FIG. 10.

As can be seen in twenty five pixel grid 46 of FIG. 10, in an odd frame, the pixels at rows one and two of column one include pixels driven by positive voltage values. Next to these pixels are two pixels at rows one and two of column two that are driven by negative voltage values. This pattern is repeated for rows one and two in columns three, four, and five. In contrast, rows three and four of column one include pixels driven by negative voltage values, with two pixels at rows one and two of column two driven by positive voltage values. This pattern is subsequently repeated for rows three and four in columns three, four, and five. This inversion pattern may be termed two dot inversion. It should be noted that the two dot inversion may instead include pixels horizontally inverted, that is, row one at columns 1 and 2 might be driven by positive voltages, while row one at columns 3 and 4 might be driven by negative voltages in a repeating pattern, while row two at columns 1 and 2 might be driven by negative voltages, while row two at columns 3 and 4 might be driven by positive voltages in a repeating pattern, etc.

Thus, in a two dot inversion method, two pixels at a time are driven to positive and two pixels at a time are driven to negative voltages. In contrast, every other pixel alternates in a one dot inversion method. As stated above, an advantage of the two dot inversion method may include a reduction in power consumed by display 14. The utilization of the two dot inversion method may also lead to lower flicker levels than if a one dot inversion method is utilized. It should be further noted that other inversion configurations may be utilized. For example, inversion of pixels grouped together to include pixels in one column and two or more rows, in two or more columns with one or more rows, in one row with two or more columns, and/or in two rows with two or more columns are contemplated for use with the inversion and dithering and inversion method described below.

FIG. 11 illustrates combination of a two dot inversion method utilized in conjunction with temporal dithering. As can be seen in FIG. 11, four pixel grid 48 may approximate an intensity level of four pixels each equivalent to “1”. In the first frame of FIG. 11, the pixel that displays an intensity level of “4” may be in the upper left hand quadrant of four pixel grid 48. Moreover, the leftmost side of four pixel grid 48 may be driven with positive voltages, shown via the shaded regions of four pixel grid 48, since the two dot inversion method drives rows one and two of column one with positive voltage during an odd frame. In the second frame the pixel that displays the intensity level of “4” may be in the rightmost quadrant of four pixel grid 48. Due to the two dot inversion method of providing positive voltage signals to rows one and two of column two during even frames, the pixel intensity of “4” in the upper rightmost quadrant again receives a positive voltage value when driven to its intensity level. As the pixel intensity level of “4” is positioned in the lower rightmost quadrant in Frame 3, the pixel intensity level of four in the lower rightmost quadrant of four pixel grid 48 is shown as being driven with a negative voltage. Similarly, in Frame 4, the intensity level of “4” in the lower leftmost quadrant of four pixel grid 48 is driven with a negative intensity, in conjunction with the two dot inversion method.

In this example, the pixel intensity level is driven with positive voltages for two frames and with negative voltages for two frames. However, the positive and negative voltages used to drive the pixels may not be identical in voltage magnitude, as the voltages tend to differ slightly. For example, if the pixels are intended to be driven to a +3V voltage and a −3V voltage, the +3V (positive) voltage may be actually driven at 3.1 volts whereas the −3V (negative) voltage may actually be driven at −2.9 volts.

Because the magnitudes of the positive and negative driving voltages typically differ, and because the pixel intensity level of “4” is driven by positive voltage in the top most half of four pixel grid 48 and driven by negative voltage in the lower most half of four pixel grid 48, differences in brightness on display 14 may occur. These differences in brightness may result in horizontal artifacts in display 14. To overcome these horizontal artifacts, a dithering technique may be applied as illustrated in FIG. 12.

FIG. 12 illustrates four pixel grid 50 that drives a single pixel to an intensity level of “4”, while the three remaining intensity levels of four pixel grid 50 are driven to “0” every frame to simulate four pixel intensity levels of “1”. It should be noted that this is merely an example for illustrative purposes, and any of the dithering mechanisms described with respect to FIGS. 4-6 may be utilized. Similar to four pixel grid 48, in Frames 1 and 2, the pixel in the upper left most quadrant of four pixel grid 50 and the pixel in the upper right most quadrant, respectively, are driven to an intensity level of “4”. In both Frame 1 and Frame 2, the intensity level of “4” coincides with a positive driving voltage via a two dot method.

In Frame 3, however, the temporal dithering of FIG. 12 diverges from the temporal dithering of FIG. 11. In Frame 3, it can be seen that the pixel in the lower left hand quadrant of four pixel grid 50 is driven to an intensity level of “4”. Moreover, the intensity level of “4” is in the lower left hand quadrant occurs during an odd frame of the two dot inversion method, so it is being driven with positive voltage. Similarly, in Frame 4, as the pixel intensity level of four rotates to the pixel in the lower right hand corner of four pixel grid 50, the two dot inversion method causes the pixel being driven to an intensity level of “4” to be driven with positive voltage. Thus, the dithering of the pixels in four pixel grid 50 causes the pixels with a pixel intensity of “4” to be continuously driven with positive voltage. Accordingly, no horizontal artifacts may be created as a result of temporal dithering in conjunction with the two dot inversion method because the pixels driven to an intensity level of “4” are always being driven with the same (i.e., either positive or negative) voltage. Thus, differences in the actual magnitude of the positive and negative driving voltages will not impact the intensity of the pixels driven to an intensity level of “4”.

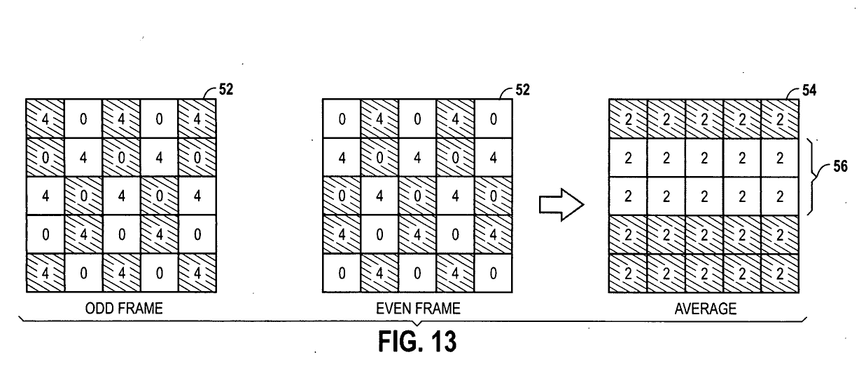

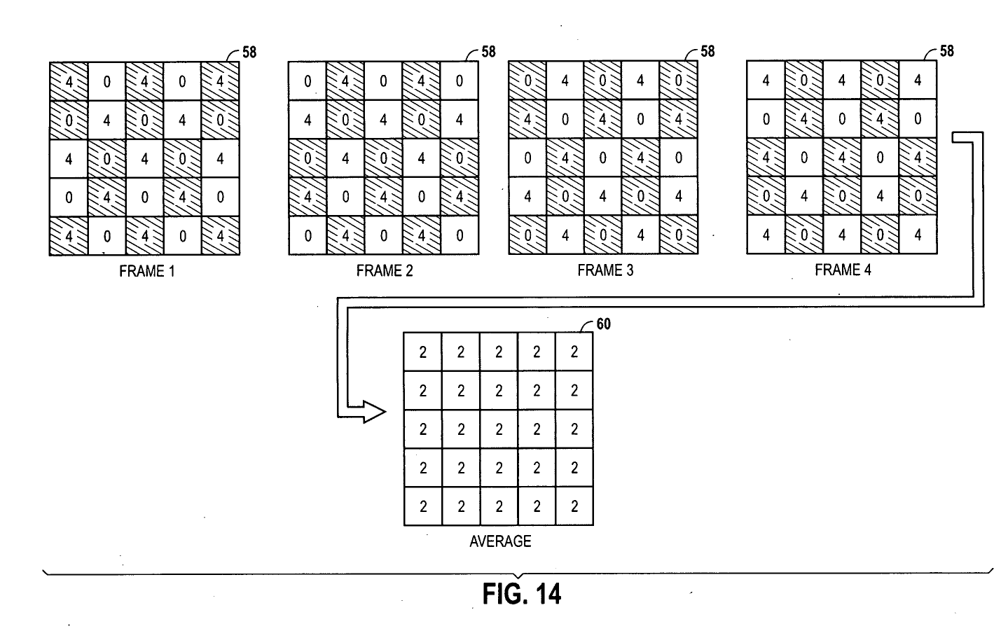

FIGS. 13 and 14 illustrate an example of the optical differences between a method of dithering in FIG. 13 and method of dithering in combination with a two dot inversion method in FIG. 14. FIG. 13 shows an illustration of twenty-five pixel grid 52 during an odd frame and an even frame, as well as an approximate intensity average twenty-five pixel grid 54. Twenty-five pixel grid 52 may utilize temporal and spatial dithering, for example, as illustrated in FIG. 8. As such, during an odd frame, the pixels driven in twenty-five pixel grid 52 to an intensity level of “4” via a positive voltage may be located in rows one, four, and five, while the pixels driven in twenty-five pixel grid 52 to an intensity level of “4” via a negative voltage may be located in rows two and three. During even frames, as can be seen in FIG. 13, the pixels driven to intensity levels of “4” via positive voltage are again located in the first, fourth, and fifth rows whereas the pixels driven to intensity levels of “4” in the second and third rows are driven by negative voltage in twenty five pixel grid 52.

This dithering may lead to an overall average intensity of “2” for the entirety of the pixels in the twenty-five pixel grid 54. However, as can be seen in twenty-five pixel grid 54, the second and third rows of twenty-five pixel grid 54 may be driven to different, for example, lower, voltage than the first, fourth, and fifth rows of twenty-five pixel grid 54, causing horizontal artifacts 56 to be displayed. These horizontal artifacts 56 may be due to the positive and negative voltages of display 14 being driven at different overall magnitudes.

FIG. 14 illustrates a dithering method that may be utilized to eliminate the creation of these horizontal artifacts 56 due to differing displayed intensities in rows two and three from rows one, four, and five. In Frame 1, twenty-five pixel grid 58 may mirror twenty-five pixel grid 52 utilized in odd frames. Similarly, in Frame 2 of FIG. 14, twenty-five pixel grid 58 may corresponds to the even frame of twenty-five pixel grid 52. However, in Frame 3, twenty-five pixel grid 58 ceases to correspond to the odd frame of twenty-five pixel grid 52. Instead, in Frame 3, twenty five pixel grid 58 corresponds to twenty five pixel grid 52 of an even frame. Finally, Frame 4 illustrates that twenty five pixel grid 58 corresponds not to an even frame of FIG. 13, but rather the odd frame configuration of twenty five pixel grid 52. Therefore, in FIG. 14, twenty-five pixel grid 58 rotates through four frames in a manner consistent with the rendition of twenty five pixel grid 58 in an odd fame, an even frame, an even frame, and an odd frame. By rotating in this manner, pixels in the rows one, four, and five of twenty five pixel grid 58 are driven to a pixel intensity of “4” by a positive voltage for two frames and by a negative voltage for two frames. Similarly, rows two and three of twenty five pixel grid 58 are subject to being driven by negative voltages for two frames and positive voltages for two frames.

Overall, this pattern may results in an approximate intensity average of “2” at all pixel locations. More importantly though, the visual artifacts associated with the pixels in rows one, four, and five versus rows two and three in twenty-five pixel grid 54 may be eliminated, as illustrated by twenty-five pixel grid 60. Furthermore, it should be noted that Frames 1, Frames 2, Frames 3, and Frames 4 may be mathematically generalized to an equation of 4n, 4n+1, 4n+2, 4n+3. That is, the pattern for Frame 1 will repeat for the fifth frame, the ninth frame, etc., while Frame 2 will repeat in the sixth frame, the tenth frame, etc. and so forth. Thus, by utilization of this dithering method, the time average of the pixels for twenty-five pixel grid 58 of FIG. 14 may equivalent to that illustrated in the approximate intensity average twenty-five pixel grid 54, without the formation of horizontal line artifacts 56.

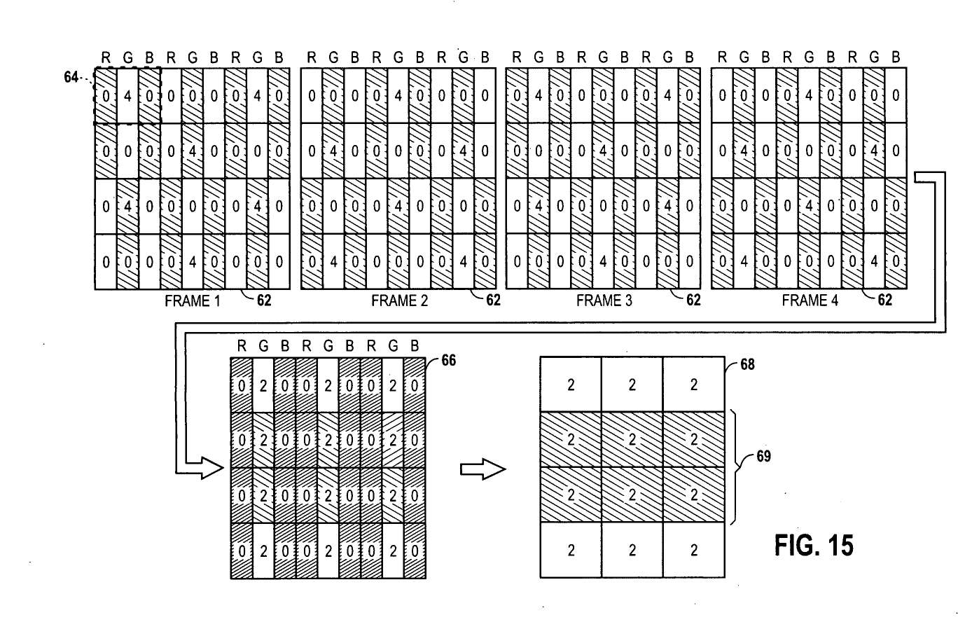

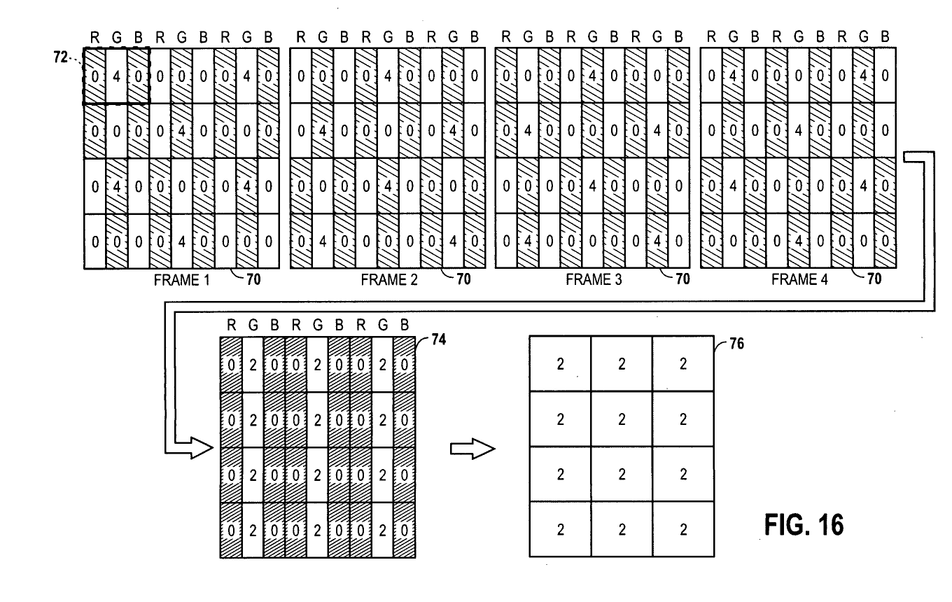

FIGS. 15 and 16 illustrate another example of the optical differences between a method of dithering in FIG. 15 and method of dithering in combination with a two dot inversion method in FIG. 16. FIG. 15 shows an illustration of twelve pixel grid 62 during four frames, organized into three rows and four columns. As illustrated, twelve pixel 62 that may include twelve pixels 64, each of which includes a red, a green, and a blue sub-pixel. FIG. 15 further illustrates sub-pixel intensity average grid 66 and pixel intensity average grid 68.

Twelve pixel grid 62 may utilize temporal and spatial dithering, as well as two dot inversion. As illustrated, the red and blue sub-pixels are driven to intensity levels of “0”, that is, the red and blue sub-pixels are turned off. In contrast, the green sub-pixels of twelve pixel grid 62 are dithered. Specifically, the green sub-pixels are driven to an intensity level of “4” in the pixels at rows 1 and 3, columns 1 and 3, and rows 2 and 4, column 2, in Frames 1 and 3. The green sub-pixels are likewise driven to an intensity level of “4” in the pixels at rows 1 and 3, column 2, and rows 2 and 4, columns 1 and 3, in Frames 2 and 4. It should be noted that while this dithering has been described with respect to green sub-pixels, it is contemplated that any combination of the red, green, and blue sub-pixels of twelve pixel grid 62 may utilize the dithering technique described above.

The dithering of the sub-pixels may lead to an overall average intensity of “2” for the green sub-pixels of the sub-pixel intensity average grid 66. This may also be illustrated in pixel intensity average grid 68. However, as can be seen in pixel intensity average grid 68, the second and third rows of pixel intensity average grid 68 may be driven to a different, for example, higher, voltage than the first and fourth rows of the pixel intensity average grid 68, causing horizontal artifacts 69 to be displayed. Horizontal artifacts 69 may be due to the positive and negative voltages of display 14 being driven at different overall magnitudes.

FIG. 16 illustrates a dithering method that may be utilized to eliminate the creation of horizontal artifacts 69 due to differing displayed intensities in rows two and three from rows one and four of FIG. 15. In Frame 1 of FIG. 16, twelve pixel grid 70 may mirror twelve pixel grid 62 of FIG. 15 utilized in odd frames. Similarly, in Frame 2 of FIG. 16, twelve pixel grid 70 may correspond to the even frames of twelve pixel grid 62 of FIG. 15. However, in Frame 3, twelve pixel grid 70 ceases to correspond to the odd frames of twelve pixel grid 62. Instead, in Frame 3, twelve pixel grid 70 corresponds to twelve pixel grid 62 of an even frame. Finally, in Frame 4, twelve pixel grid 70 corresponds not to an even frame of FIG. 15, but rather the odd frame configuration of twelve pixel grid 62. Therefore, in FIG. 16, twelve pixel grid 70 rotates through four frames in a manner consistent with the rendition of twelve pixel grid 62 in an odd fame, an even frame, an even frame, and an odd frame. By rotating in this manner, pixels 72 in the rows one and four of twelve pixel grid 70 are driven to a pixel intensity of “4” by a positive voltage for two frames and by a negative voltage for two frames. Similarly, rows two and three of twelve pixel grid 70 are subject to being driven by negative voltages for two frames and positive voltages for two frames.

Overall, this pattern may results in an approximate intensity average of “2” for the green sub-pixels of sub-pixel intensity average grid 74. This may also be illustrated in pixel intensity average grid 76. More importantly though, the visual artifacts associated with the pixels in rows one and four versus rows two and three in twelve pixel grid 70 may be eliminated, as illustrated by twenty-five pixel grid 60. Furthermore, it should be noted that Frames 1, Frames 2, Frames 3, and Frames 4 may be mathematically generalized to an equation of 4n, 4n+1, 4n+2, 4n+3. That is, the pattern for Frame 1 will repeat for the fifth frame, the ninth frame, etc., while Frame 2 will repeat in the sixth frame, the tenth frame, etc. and so forth. Thus, by utilization of this dithering method, the time average of the pixels for twelve pixel grid 70 of FIG. 16 may equivalent to that illustrated in pixel intensity average grid 76, without the formation of horizontal line artifacts 69.

While the various embodiments may be susceptible to various modifications and alternative forms, specific embodiments have been shown by way of example in the drawings and have been described in detail herein. However, it should be understood that the claims are not intended to be limited to the particular forms disclosed. Rather, the claims are to cover all modifications, equivalents, and alternatives falling within the spirit and scope of the disclosure.

What is claimed is:

1. A method of spatially and temporally dithering a pixel frame having pixels (R,C) arranged in two rows (R) by two columns (C), the method comprising:
positively driving pixels (1,1) and (2,1) and negatively driving pixels (1,2) and (2,2) during a first frame N;
driving the pixel (1,1) to a first intensity level and the pixels (2,1), (1,2), and (2,2) to a second intensity level during the first frame N, wherein the second intensity level differs from the first intensity level;
positively driving pixels (1,2) and (2,2) and negatively driving pixels (1,1) and (2,1) during a second frame N+1;
driving the pixel (1,2) to the first intensity level and the pixels (1,1), (2,1), and (2,2) to the second intensity level during the second frame N+1;
positively driving pixels (1,1) and (2,1) and negatively driving pixels (1,2) and (2,2) during a third frame N+2;
driving the pixel (2,1) to the first intensity level and the pixels (1,1), (1,2), and (2,2) to the second intensity level during the third frame N+2;
positively driving pixels (1,2) and (2,2) and negatively driving pixels (1,1) and (2,1) during a fourth frame N+3; and
driving the pixel (2,2) to the first intensity level and the pixels (1,1), (1,2), and (2,2) to the second intensity level during the fourth frame N+3.

2. The method of claim 1, wherein the first intensity level is greater than the second intensity level.

3. The method of claim 1, wherein the first intensity level is less than the second intensity level.

4. The method of claim 1, comprising repeating the steps in the recited order for all frames subsequent to the fourth frame N+3.

5. The method of claim 1, comprising repeating the steps in the recited order for a plurality of pixel frames.

6. An electronic device, comprising:
a processor adapted to transmit image data corresponding to a first image code;
a display adapted to display image data corresponding to a second image code; and
display control logic adapted to:
convert the image data corresponding to the first image code to image data corresponding to the second image code;
generate and transmit inversion signals to the display, wherein the inversion signals are utilized to alternately positively and negatively drive respective pixels in a pixel frame of the display, wherein the pixel frame comprises pixels arranged in two rows by two columns; and
generate and transmit spatial and temporal dithering signals, wherein the spatial and temporal dithering signals are utilized to drive one of the positively driven pixels in the pixel frame to a first intensity level and to drive the pixels immediately adjacent to the one of the positively driven pixels in the pixel frame to a second intensity level, wherein the second intensity level differs from the first intensity level.

7. The electronic device of claim 6, wherein the inversions signals correspond to a two dot frame inversion technique.

8. The electronic device of claim 6, wherein image data corresponding to the first image code comprises 24-bits of data, wherein the 24-bits of data corresponds to 8-bits of data corresponding to each of a red, blue, and a green color level.

9. The electronic device of claim 6, wherein image data corresponding to the second image code comprises 18-bits of data, wherein the 18-bits of data corresponds to 6-bits of data corresponding to each of a red, blue, and a green color level.

10. The electronic device of claim 6, wherein the spatial and temporal dithering signals are generated on a frame by frame basis.

11. The electronic device of claim 10, wherein the spatial and temporal dithering signals drive a different one of the positively driven pixels in the pixel frame to the first intensity level and drive the pixels immediately adjacent to the one of the positively driven pixels in the pixel frame to the second intensity level for each frame.

12. The electronic device of claim 6, wherein the display control logic comprises memory adapted to store computer readable code for generating the inversion signals.

13. The electronic device of claim 6, wherein the display control logic comprises memory adapted to store computer readable code for generating the spatial and temporal dithering signals.

14. The electronic device of claim 6, wherein the inversion signals are utilized to alternately positively and negatively drive the two rows of the pixel frame.

15. The electronic device of claim 6, wherein the inversion signals are utilized to alternately positively and negatively drive the two columns of the pixel frame.

16. A method of spatially and temporally dithering a pixel signal, the method comprising:
for a pixel frame having pixels (R,C) arranged in four rows (R) by four columns (C), wherein the pixel frame comprises four sub-frames each arranged in two rows and two columns:
positively driving pixels (1,1), (2,1), (1,3), (2,3), (3,2), (4,2), (3,4) and (4,4) and negatively driving pixels (1,2), (2,2), (1,4), (2,4), (3,1), (4,1), (3,3) and (4,3) during a first frame N, wherein each pixel is driven at a respective intensity level;
positively driving pixels (1,2), (2,2), (1,4), (2,4), (3,1), (4,1), (3,3) and (4,3) and negatively driving pixels (1,1), (2,1), (1,3), (2,3), (3,2), (4,2), (3,4) and (4,4) during a second frame N+1, wherein each pixel is driven at the respective intensity level of a pixel immediately adjacent it in its row of its respective sub-frame during the first frame N;
positively driving pixels (1,1), (2,1), (1,3), (2,3), (3,2), (4,2), (3,4) and (4,4) and negatively driving pixels (1,2), (2,2), (1,4), (2,4), (3,1), (4,1), (3,3) and (4,3) during a third frame N+2, wherein each pixel is driven at the respective intensity level as during the second frame N+1; and
positively driving pixels (1,2), (2,2), (1,4), (2,4), (3,1), (4,1), (3,3) and (4,3) and negatively driving pixels (1,1), (2,1), (1,3), (2,3), (3,2), (4,2), (3,4) and (4,4) during a fourth frame N+3, wherein each pixel is driven at the respective intensity level as during the first frame N.

17. The method of claim 16, comprising driving the pixels (1,1), (2,2), (1,3), (2,4), (3,1), (4,2), (3,3) and (4,4) to a first intensity level during the first frame N.

18. The method of claim 17, comprising driving the pixels (1,2), (2,1), (1,4), (2,3), (3,2), (4,1), (3,4) and (4,3) to a second intensity level during the first frame N, wherein the second intensity level differs from the first intensity level.

19. The method of claim 18, wherein the first intensity level is greater than the second intensity level.

20. The method of claim 19, comprising selecting the first and second levels to generate an average pixel intensity for the pixel frame.

21. A graphics processor adapted to:
generate pixel inversion signals for each of a plurality of pixel frames, where each pixel frame comprises four pixels arranged in two rows and two columns, wherein the pixel inversion signals are utilized to drive one of the rows or columns of pixels of each pixel frame to a first inversion level and to drive the other of the rows or columns of pixels of each pixel frame to a second inversion level during a first frame N and a third frame N+2, to drive the other of the rows or columns of pixels of each pixel frame to the second inversion level and to drive the one of the rows or columns of pixels of each pixel frame to the first inversion level during a second frame N+1 and a fourth frame N+3, wherein the first and second inversion levels are different inversion levels; and
generate dithering signals, wherein the dithering signals drive:
a first one of the four pixels of each pixel frame to a first intensity level while driving the remaining pixels of each pixel frame to a second intensity level in the first frame N, wherein the first one of the four pixels is driven to a selected one of the first inversion level or the second inversion level for each respective frame;
a second one of the four pixels of each pixel frame to the first intensity level while driving the remaining pixels of each pixel frame to the second intensity level in the second frame N+1, wherein the second one of the four pixels of the pixel frame is driven to the selected one the first inversion level or the second inversion level for each respective frame;
a third one of the four pixels of each pixel frame to the first intensity level while driving the remaining pixels of each pixel frame to the second intensity level in the third frame N+2, wherein the third one of the four pixels is driven to the selected one the first inversion level or the second inversion level for each respective frame; and
a fourth one of the four pixels of each pixel frame to the first intensity level while driving the remaining pixels of each pixel frame to the second intensity level in a fourth frame N+3, wherein the fourth one of the four pixels is driven to the selected one the first inversion level or the second inversion level for each respective frame.

22. The graphics processor of claim 21, wherein the graphics processor is adapted to generate two symbol dithering signals, wherein the two symbol dithering signals drive a first two diagonally adjacent pixels of each pixel frame to the first intensity level and drive a second two diagonally adjacent pixels of each pixel frame to the second intensity level in the first frame N and the fourth frame N+3, and drive the first two diagonally adjacent pixels of each pixel frame to the second intensity level and drive the second two diagonally adjacent pixels of each pixel frame to the first intensity level in the second frame N+1 and the third frame N+2.

23. The graphics processor of claim 21, wherein the first inversion level corresponds to a positive voltage value and the second inversion level corresponds to a negative voltage value.

24. The graphics processor of claim 21, wherein the graphics processor is adapted to retrieve computer code for generating the pixel inversion signals from memory and to execute the computer code to generate the pixel inversion signals.

25. The graphics processor of claim 21, wherein the graphics processor is adapted to retrieve computer code for generating the dithering signals from memory and to execute the computer code to generate the dithering signals.
